(19) United States
(12) Patent Application Publication
(10) Pub. No.: US 2010/0108234 A1
(43) Pub. Date: May 6, 2010

(54) Dual-character shock isolation methodology

(75) Inventors: Michael R. Dennis, St. Helens, OR (US); Casey A. Dennis, Sequim, WA (US)

Correspondence Address: ROBERT D. VARITZ, P.C., 4915 SE 33RD PLACE, PORTLAND, OR, 97202, US

(73) Assignee: MJD Innovations, L.L.C.

(21) Appl. No.: 12/655,672

(22) Filed: Jan. 5, 2010

Related U.S. Application Data
(62) Division of application No. 12/082,264, filed on Apr. 8, 2008.
(60) Provisional application No. 60/922,806, filed on Apr. 10, 2007.

(51) Int. Cl. B32B 37/00

(52) U.S. Cl. 156/60

(57) ABSTRACT

A shock-mitigating method which is practiceable in a connective interface existing between a pair of interconnected structures, wherein the fundamental practice steps include (a) on one side of that interface, engaging any shock-transmission event with a cushioning material which is characterized by kinetic-energy-to-heat conversion behavior, and (b), on the other side of the interface, engaging such an event with a material which is in shock communication with the cushioning material, and which is characterized by shear-lock behavior.

### CROSS REFERENCE TO RELATED APPLICATION

This application is a division of currently copending U.S. patent application Ser. No. 12/082,264, filed Apr. 8, 2008, for “Dual-Character Shock Isolation Structure and Methodology”, which application claims priority to prior-filed U.S. Provisional Patent Application Ser. No. 60/922,806, filed Apr. 10, 2007, for “Shear-Lock, Shock-Minimizing, Impact-Device Handle and Related Structure”. The entire disclosure contents of these applications are hereby incorporated herein by reference.

### BACKGROUND AND SUMMARY OF THE INVENTION

This invention relates to shock-mitigating, or shock-isolating, methodology for minimizing, through dual-character (or dual-mode) isolation, the transmission of impulse shock from one structure to another, such as from the gripping structure, like the handle, in a hand-holdable impact tool, or similar instrumentality, to the hands, arms, i.e., generally the anatomy, of an impact-tool user. While it will be clearly apparent to those skilled in the art that the methodology of the invention has wide applicability, a preferred and best-mode form of, and manner of practicing, the invention are described herein especially in the setting just mentioned of mitigating shock-transmission to and within the human anatomy, a setting wherein the invention has been found to offer particular utility. Utility of the invention in environments not involving the anatomy will, from an appreciation of the human anatomical environment illustrations presented below herein, be immediately understandable to those skilled in the art.

In the setting involving the human anatomy, the invention methodology-illustration employed herein involving the use of an impact tool, and specifically the hand-gripping structure, or hand-holdable structure, or component, of such a tool, should be interpreted appropriately broadly.

The features of the invention, in relation to protecting the anatomy, are, in particular, illustrated and described herein in the contexts of two different kinds of representative impact tools, referred to herein as shock-delivery tools which deliver shock/impact to the anatomy of a user. One of these two illustrative tools takes the form of an axe, and the other takes the form of a pneumatically-powered riveting gun of the type used, for example, in the aircraft-building industry.

It should be understood that the terminology “impact tool”, as was suggested above, and as such is employed herein, is intended to refer to any category of hand-holdable, or hand-engageable, impact device, or structure, having an included hand-gripping, or hand-supporting, or manipulating, or engaging structure, such as a handle (or like component), through which shock or impact events may be communicated/transmitted to a user.

It is well known that impact shock, such as that generally mentioned above, is stressful, and may sometimes be injurious, to the gripping hands and the arms, or other anatomy of an impact-tool user. Customary, basic, relatively simple, cushioning-type tool-handle jackets, or handles which, per se, are formed of traditional cushioning materials, while helpful, nevertheless leave much room for improvement in terms of blocking impact transmission in the usual shock-transmission path, or connective interface, which naturally exists between such a tool and its user.

Additionally, the connective interface existing between a user's hands and a tool handle of the type now being described is normally characterized by “tight grip” which results from a tensing of a user's hand and arm muscles so as to hold the associated tool securely, and to enable the hand and the arm to maneuver the tool appropriately when it is being used. There is thus normally, and “instinctively”, a very close, tight-grip tool coupling which exists at the surface of the hand. Such a tight-grip coupling, which “anchors” a tool to the hand, invokes a very effective and efficient shock-transmission anatomical medium extending through the hand and the arm in the form of tensed muscles, which muscles function to deliver into the user's hands and arms whatever shock load is made available at the surface of the hand.

If one thinks about this condition, one will recognize that were it possible to provide an arrangement wherein the muscular aspect of a grip could be minimized, and therefore attendant muscular tension relaxed, the shock-transmission efficiency of the muscles could be greatly reduced, and as a consequence, an even greater (than that attainable by cushioning alone) reduction of impact and shock transmission into the anatomy could be achieved. This possibility is realized in the implementation of the present invention.

As will be seen, the present invention specifically addresses the above-mentioned need for improvement in an extremely satisfactory manner. In the context of describing the invention in the important illustrative environment of impact tool use, it does so by proposing, for implementation of the invention methodology, use of a novel shock-isolating, or shock-mitigating, structure which includes, among other things, a very efficient, kinetic-energy-to-heat, shock-reducing cushioning wrap, or structure, attached to the user-gripping region of an impact-tool handle, and a twin-layer shear-lock structure which is interposed operatively the cushioning wrap and the gripping hand, or hands, of that tool's user.

In environments other than those involving shock-mitigation relative to the anatomy, the same effective combination of cushioning and shear-lock structures are employed in accordance with the invention.

The kinetic-energy-to-heat cushioning material preferably employed takes the form of one, or plural, layers of a low-rebound, viscoelastic, acceleration-rate-sensitive foam material. Ideally, this foam material is employed in as thin a layer arrangement, overall, as is practical.

The shear-lock structure includes a pair of shear-lock fabric layers, or layer expanses, one of which is attached, effectively, to the outer surface of the cushioning wrap, which is more directly secured to a tool handle, and the other of which is attached to a glove, or other, typically hand-worn garment, employed by a tool user during tool use. These shear-lock fabric layers are organized with confrontable, interengageable and releaseable shear-lock faces defined each by a distribution of plural, closely spaced, shear-lock projections, which faces releaseably and selectively interlock on contact against relative shear motion, yet which may be easily unlocked via a kind of relative peeling motion between the two layers of material.

Where two hands of a user must be employed, each hand is furnished with an appropriate glove, or the like, that carries a shear-lock fabric layer of the type just generally described.

A suitable shear-lock material is that which is made by the 3M Corporation, and sold under the trademark Greptile™.

A suitable low-rebound, viscoelastic, acceleration-rate-sensitive material—the cushioning-structure material—takes the form of one or more appropriate-thickness layers of selected-density, “slow rebound” PORON®—a microcellular urethane foam material made by Rogers Corporation in Woodstock, Conn. Different densities and thicknesses of this material are available and may readily be chosen to suit different specific applications. In the two invention illustrations provided herein, a single, 3-mm thick layer of pink, slow rebound PORON® material, designated 4708, has been found to be very satisfactory.

While other materials, including certain adhesives, a thin layer of nylon fabric, and at least one other type of layer material, mentioned below, are employed, as will be explained, in the overall assembly of materials used illustratively herein in the practice of the present invention, it is our impression that, within the composite mix of all of the materials employed, the acceleration-rate-sensitive material and the shear-lock material play the key roles in implementing the methodologic features of the invention.

In general terms, these two materials, or structures, as was mentioned earlier herein, form parts, or portions, of what is referred to herein as a dual-character shock-mitigating, or shock-isolating, structure having spaced, opposite facial expanses. Effectively, these two cooperative materials between the mentioned opposite facial expanses, “sit” between the two external structures, i.e., in the connective interface therebetween, with respect to which shock-transfer mitigation is to take place. The cushioning-structure material is disposed preferably toward, and lies closely adjacent, one of these mentioned, opposite facial expanses, and the shear-lock material is disposed toward, and lies closely adjacent, the other such expanse.

In the “tool-grip” situation, the acceleration-rate-sensitive cushioning material significantly reduces the level of impulse shock which is deliverable through the tool-grip interface which exists between the gripping handle of the relevant impact tool and a user's hand(s). This material furnishes one part of the dual-character/dual-mode behavior of the invention.

The shear-lock structure, which, preferably, is effectively interposed the acceleration-rate-sensitive material and a tool-user's hand(s), performs at least three, closely linked, significantly cooperative (with the acceleration-rate-sensitive material) shock-mitigating functions. In particular, this shear-lock structure promotes, on its own, (a) an appreciable level of shock-transmission mitigating, (b) the establishment of an extremely tenacious, but releaseable, de facto working grip (an anchoring) between a user's hand(s) and an impact tool, while at the same time (c) actually enabling, in relation to conventional practice, significantly reduced muscular effort, i.e., muscular tension, on the part of a user to establish an appropriate tool-holding hand grip (anchoring). The shear-lock structure thus furnishes the other part of the dual-character/dual-mode behavior of the invention.

Thus, and in a more specific sense, the shear-lock structure, per se, while promoting the mentioned, tenacious, de facto working tool-grip, acts as a poor outward (from tool handle to user) conveyor of impact shock. In other words, it provides a good shock de-coupling mechanism. The shear-lock structure simultaneously promotes more relaxed muscular tensioning in a user's hand(s) and arm(s), inasmuch as its shear-lock functionality significantly contributes to tool-gripping tenacity, and thus tends to minimize the gripping force required of a user. As a consequence, it effectively makes the relevant, more-relaxed user muscles poorer (than usual) internal anatomical transmitters of shock. This last thought, as will be seen, is very important in terms of recognizing the capability of the present invention to minimize greatly the potential for anatomical injury otherwise potentially receivable by a user, especially after long periods, typically, of impact-tool usage.

Together, the low-rebound, viscoelastic, acceleration-rate-sensitive cushioning material, and the shear-lock material, cooperate to furnish remarkable impact shock isolation and mitigation between an impact-delivering tool and a user's anatomy. The cushioning material minimizes shock transmission from an impact-tool handle to the adjacent shear-lock material, and the shear-lock material, while also minimizing the “ongoing” delivery of shock to a user, minimizes, through promoting internal muscular relaxation, the user's anatomy's capability of transmitting shock internally in the anatomy.

As will be seen somewhat similar functionality characterizes the behavior of the present invention in non-anatomical settings.

The various important features and advantages of the present invention will become more fully apparent as the more detailed description thereof presented below is read in conjunction with the accompanying drawings.

### DESCRIPTION OF THE DRAWINGS

FIG. 1 is a side elevation of an axe with a handle which has been wrapped with a portion of a preferred and best-mode embodiment of the dual-character shock-isolation structure relevant illustratively to practice of the present invention.

FIG. 2 illustrates a tool-holding glove which may be used to handle and operate the axe of FIG. 1, and which, in relation to what appears in FIG. 1, includes the remaining portion of shock-mitigating structure employable in the implementation of the present invention.

FIG. 3 is a fragmentary cross-sectional view illustrating, collectively, the two portions of the shock-isolating structure discussed herein, with these two portions being shown in solid outline spaced from and facing one another. In fragmentary dash-double-dot lines in this figure (for just one of the two shock-isolating structure portions), the two shock-isolating structural portions are shown connected through included shear-lock layer expanses.

FIG. 4 is a side elevation of a power-driven riveting tool whose handle has been equipped with the same portion of the illustrative shock-isolating structure which is shown on the handle of the axe in FIG. 1.

FIG. 5 is a simplified fragmentary drawing showing a more generalized (non-anatomical) use of the invention in a coupling/anchoring interface which exists between a pair of mechanical structures, one of which has a behavior which transmits shock to the other structure.

### DETAILED DESCRIPTION OF THE INVENTION

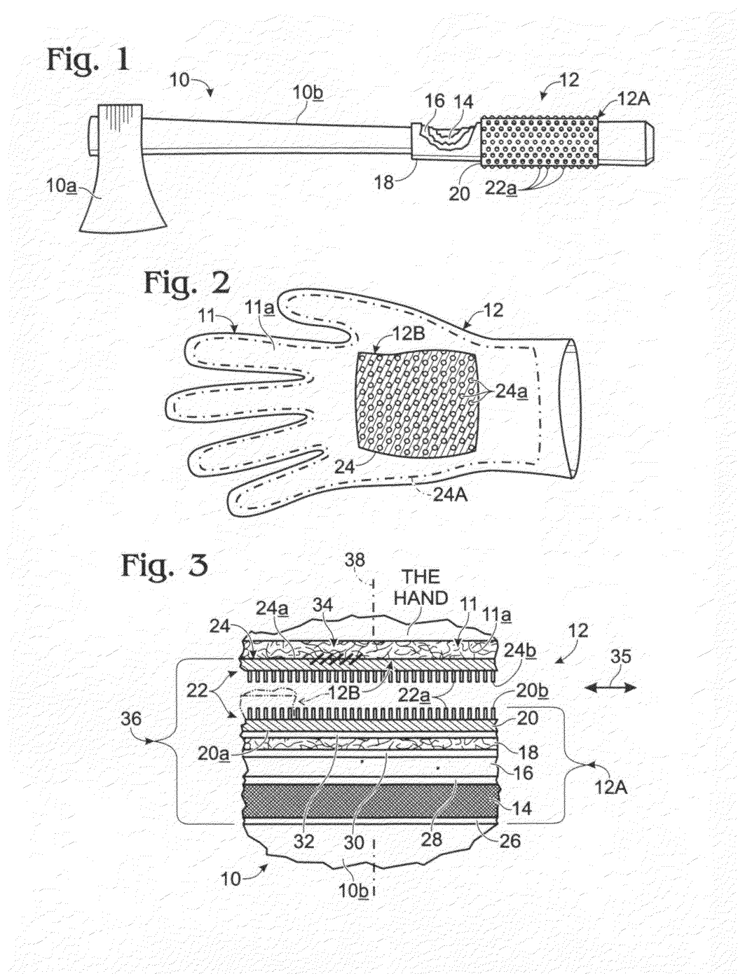

Turning now to the drawings and referring first of all to FIGS. 1-3, inclusive, indicated generally at 10 is an axe having a head 10a and handle 10b, and at 11 is a user-wearable glove having what is referred to herein, generally on its palm side, as an outer working surface 11a. Axe 10 is also referred to herein as a tool, as shock-delivering tool, and as a tool which delivers shock impact to the hands and arms, i.e., to the anatomy, of a user. Handle 10b is also referred herein as a hand-gripping component.

Indicated generally at 12 in FIGS. 1, 2 and 3 is dual-character (dual-mode), shock-isolation (shock-mitigating) structure constructed to enable practice of the present invention. As can be seen, structure 12 is in fact divided into two parts, or portions, 12A and 12B, with portion 12A being affixed to axe handle 10b, and portion 12B being affixed centrally to the outer working surface 11a in glove 11.

Focusing attention for a moment particularly on FIG. 3, here, the internal structures of these two shock-mitigating-structure portions, 12A, 12B are shown. They are shown in a size-exaggerated fashion in order to make their presences and relative dispositions evident. Focusing first of all upon the make-up of portion 12A, in addition to certain bonding adhesives which will be described shortly, this portion of the shock-mitigating structure essentially contains four material layers, including a kinetic-energy-to-heat cushioning structure 14, a fabric layer 16, a compression-wrap layer 18, and a layer expanse 20, also referred to herein as a first layer expanse, of a twin-layer shear-lock fabric structure shown generally (collectively) at 22. As can be seen from the two lead-line arrows which extend from reference numeral 22 in FIG. 3, this just-mentioned shear-lock fabric structure has one of its layer expanses, namely, just-mentioned layer expanse 20, associated with tool handle 10b. Its other layer expanse, which is shown at 24, is associated, as will shortly be explained, with previously mentioned glove 11.

Cushioning layer 14 herein, as has already been mentioned, takes the form of a low-rebound, viscoelastic, acceleration-rate-sensitive structural foam material which, in the specific setting now being described, takes the more particular form of a 3-mm thick layer of pink, slow-rebound PORON® material, designated with the product number 4708, made by Rogers Corporation in Woodstock, Conn. This layer of PORON® material is bonded to outside surface of axe handle 10b through a thin film 26 of a peel-off-backing-style adhesive material, such as that which is made by the 3M Corporation, and sold under product designator 300LSE Hi-Strength Adhesive.

Fabric layer 16 is preferably made of nylon of any suitable thickness, and is bonded to the outer surface of layer 14 through any suitable spray-on contact adhesive which is shown as a layer 28. Fabric layer 16 is essentially non-compressibly applied to PORON® layer 14.

Compression-wrap layer 18 is preferably formed of another 3M Corporation product which is referred to as Matte Black Polyurethane Protective Tape, and is preferably wound on a slight angular bias, such as at an angle of about 15° relative to a line which lies normal to the long axis of axe handle 10b, to create, within PORON® layer 14, a slight amount of pre-compression. This tape layer is preferably bonded to fabric layer 16 through another peel-off backing-style adhesive layer 30 which is essentially the same in construction as that which is employed in layer 26.

As was mentioned earlier, the shear-lock fabric material which is employed herein is preferably the material, also made by the 3M Corporation, sold under the trademark Greptile™. Each of the two layer expanses 20, 24 in shear-lock material 22 includes what is referred to herein as a non-shear-lock face, shown for layer expanses 20, 24 at 20a, 24a, respectively, and a shear-lock face, shown for these two layer expanses, respectively, at 20b, 24b. Each of these two shear-lock faces is defined by a distribution of plural shear-lock projections, such as those shown generally (for both layer expanses) at 22a in FIG. 3.

The non-shear-lock face, 20a, in layer expanse 20 is bonded to the outer surface of compression-wrap layer 18 through yet another peel-off-backing-style adhesive 32 which is like that which has been previously mentioned herein.

Completing a description of what is shown in FIGS. 2 and 3, shear-lock layer expanse 24 herein essentially makes up shock-mitigating portion 12B. The non-shear-lock face 24a in layer expanse 24, which layer expanse is also referred to herein as a second layer expanse, lies against outer working surface 11a in glove 11. Layer expanse 24 herein is joined to glove 11 through appropriate stitching, such as that suggested by the short run of angled lines shown generally at 34 in FIG. 3.

Shown only with the labeling “THE HAND” in FIG. 3, is a fragment of a user's hand which is inside glove 11. As was mentioned earlier in the description of FIG. 3, portion 12A, 12B in shock-isolating structure 12 are herein illustrated in solid outline separated slightly from one another. A fragment of shock-isolating structure portion 12B is shown in dash-double-dot lines to illustrate an operative connection between these two portions, and more specifically, an operative shear-lock connection between shear-lock layer expanses 20, 24.

Turning attention back for a moment to FIG. 2, in the particular practice embodiment of the invention now being described, shear-lock layer expanse 24 is seen to take the form of a generally palm-size, rectangular patch which is stitching-attached, as was just described, to working surface 11a in the glove. Another viable option (of many) for the shape of such a layer expanse is indicated generally at 24A in dash-dot lines in FIG. 2, with this form having somewhat of a hand shape deployed over nearly the entirety of surface 11a in glove 11, including obviously-pictured extensions that generally follow the outlines of the finger portions of the glove.

When a user employs glove 11 with tool 10, each equipped as just outlined with the embodiment of shock-mitigating structure 12 which has just been described, the user, wearing glove 11, grips handle 10 generally centrally with respect to the location of shock-mitigating portion 12A, whereupon the shear-lock projections in the two, facing, shear-lock layer expanses engage, or interengage, to provide a tenacious shear-lock grip between the glove and the tool handle. This shear-lock grip is extremely difficult to break with any relative motion shear behavior, for example as illustrated by double-headed arrow 35 in FIG. 3, but can be disengaged by what might be thought of as a peel-away type action between the two shear-lock layer expanses.

During use of axe 10, and in relation to the shock-mitigating behavior of the present invention, with portions 12A, 12B engaged, as just generally described, there exists through the shock-mitigating structure, a connective, tool-grip interface, generally shown by a bracket 36 in FIG. 3, which interface functions to mitigate shock transmission through a shock-transmission path extending through that interface, such path being indicated very generally by a dash-dot line 38 in FIG. 3. In this condition of use, the shock-mitigating characteristic of the invention may be thought of as possessing a pair of spaced, opposite facial expanses which lie within interface 36, these two facial expanses effectively being defined by the lower face of cushioning layer 14 which faces handle 10b through adhesive layer 26, and by the upper, non-shear-lock face 24a in layer expanse 24 in the shear-lock material.

During use of axe 10, and whenever a shock impact is delivered through handle 10b toward a user's hand, the dual-mode shock-mitigating mechanisms which were described earlier herein come into play. More specifically, the low-rebound, viscoelastic, acceleration-rate-sensitive foam cushioning material in layer 14 significantly reduces the level of impulse shock which is deliverable through the mentioned tool-grip interface by converting the kinetic energy associated with this shock directly into heat, and by doing this in a very pronounced manner. The shear-lock fabric structure which is interposed the cushioning material and the glove worn on a user's hand performs the earlier mentioned three, closely-linked, cooperative functions. Namely, this structure, on its own, promotes an appreciable level of shock-transmission mitigating, and couples to this action, the establishment of an extremely tenacious, but releasable, working grip which effects a secure, working anchoring between a user's hand and the axe handle, while at the same time significantly enabling, in relation to conventional experience, an appreciably reduced user muscular effort, with reduced muscular tension, required to establish an appropriate axe-holding grip during axe use.

The surprising phenomenon experienced by a user is that the user recognizes that he or she is actually applying significantly less muscular gripping tension/pressure in order to use axe 10 than would ordinarily be experienced in the absence of the presence of the shock-mitigating structure of this invention. The result, of course, is that any modest level of shock impact which actually reaches the user's hand inside the glove is extremely poorly transmitted into the anatomy because of the existing low muscular tension present in the hand and the arm.

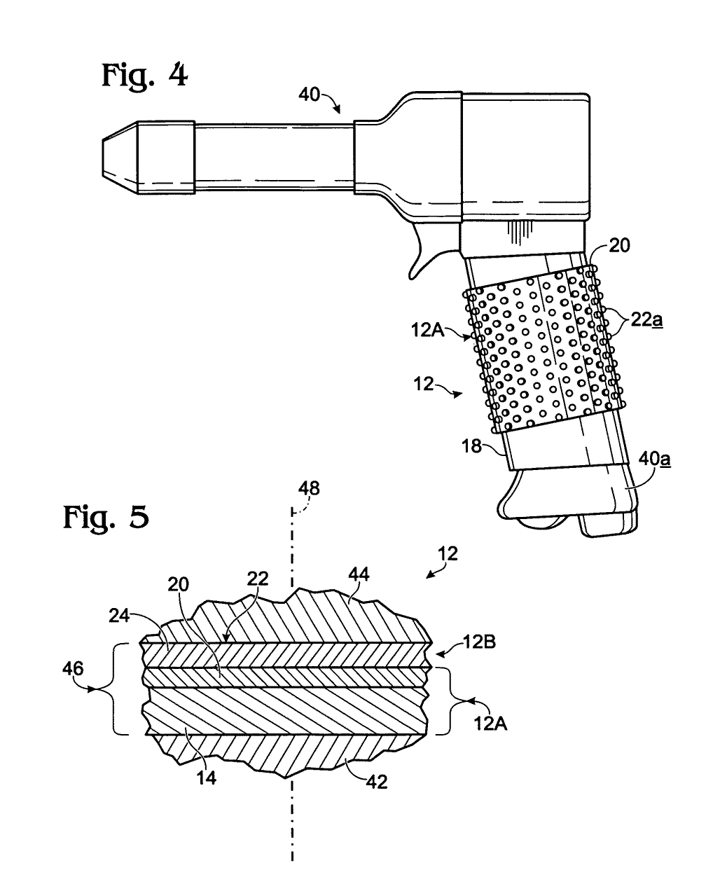

FIG. 4 in the drawings illustrates basically the same shock-mitigating environment which has just been described, but here is shown in a condition for use in conjunction with another kind of shock-delivering tool, which, in this case, takes the form of a power-driven, such as a pneumatically-driven, riveting tool 40 having a handle 40a which has been equipped with the same, previously discussed portion 12A of shock-mitigating structure 12.

With attention now directed to FIG. 5 in the drawings, this figure illustrates, in a very simplified fashion and form, and fragmentarily, implementation of the present invention, again designated generally with the reference numeral 12, set in a connective and anchoring interface which exists between two mechanical structures that are shown at 42, 44 in FIG. 5. Just for the sake of illustration herein, we will assume that structure 42 might be a machine of some sort which, when in use, delivers shock to any connected external structure, and that structure 44 is some sort of an anchoring support structure provided for this machine. The relevant connective interface between these two structures is shown by a bracket at 46 in FIG. 5, and the shock transmission path which exists through this interface between structures 42, 44 is shown by a dash-dot line 48 in FIG. 5.

In this FIG. 5 setting, the shock-mitigating characteristic of the invention performs in substantially the same fashion as that which has been described in the anatomical setting pictured and illustrated with respect to FIGS. 1-4, inclusive, herein.

Thus, a unique shock-mitigating methodology has been illustrated and described herein. In general terms, the present invention is implemented through the tenacious anchoring and coupling of two structures to one another, one of which structures has a behavior that tends to transmit shock toward to the other structure, and performing this tenacious anchoring and coupling activity in a manner where such shock transmission is greatly minimized without any appreciable cost to, or diminution in, the tenacity of structure-to-structure coupling and anchoring. Significantly contributing to this performance is the fact that the coupling/anchoring interface includes a high-performance shock-mitigator in the form of a low-rebound, viscoelastic, acceleration-rate-sensitive cushioning structure linked to a shear-lock mechanism, which two interfacial structures play the primary roles in establishing the shock-mitigating behavior of the invention.

The principal contributor to shock diminution, though not the sole contributor to it, is the acceleration-rate-sensitive cushioning material. The principal contributor to tenacity of coupling is the shear-lock material. Very importantly, anchoring and/or coupling tenacity between such two structures rests little on the introduction of internal structural tension, static or dynamic, human-muscular or otherwise, within the “other” structure which is the would-be recipient of shock transmission.

Thus, the invention features a shock-mitigating method which is practiceable in a connective interface existing between a pair of interconnected structures, wherein the fundamental practice steps include (a) on one side of the interface, engaging any shock-transmission event with a cushioning material which is characterized by kinetic-energy-to-heat conversion behavior, and (b), on the other side of the interface, engaging such an event with a material which is in shock communication with the cushioning material, and which is characterized by shear-lock behavior.

Accordingly, while a preferred and best mode embodiment of, and manner of practicing, the present invention have been disclosed herein, and certain variations suggested, we appreciate that other variations and modifications may be made without departing from the spirit of the invention.

We claim:

1. A shock-mitigating method practiceable in a connective interface existing between a pair of interconnected structures comprising
on one side of the interface, engaging any shock-transmission event with a cushioning material which is characterized by kinetic-energy-to-heat conversion behavior, and
on the other side of the interface, engaging such an event with a material which is in shock communication with the cushioning material, and which is characterized by shear-lock behavior.

2. A shock-mitigating method practiceable in a shock-transmission-path interface which exists between a shock-delivering tool and the anatomy of a user of that tool, said method comprising
on the tool side of the interface, engaging a tool-shock-delivery event substantially directly with a cushioning material which is characterized by kinetic-energy-to-heat conversion behavior, and
downstream from said engaging, creating outward, toward-a-user coupling of such cushioning-material-engaged shock delivery through a material which is characterized by shear-lock behavior.
